(19) United States
(12) Patent Application Publication
(10) Pub. No.: US 2008/0284747 A1
(43) Pub. Date: Nov. 20, 2008

(54) TOUCH CONTROL DISPLAY DEVICE

(75) Inventors: Kun-Sheng Kuo, Chu-Nan (TW); Chuan-Fu Yang, Chu-Nan (TW); Yuan-Fa Chu, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/108,003

(22) Filed: Apr. 23, 2008

(30) Foreign Application Priority Data
May 18, 2007 (CN) 200710074372.9

(51) Int. Cl. G06F 3/041

(52) U.S. Cl. 345/173

(57) ABSTRACT

A touch control display device (100) includes a base plate (120), a touch screen panel (100) arranged on the base plate, a plurality of touch-controlled light-emitting modules (130) arranged on the base plate, and a plurality of trigger electrodes (140) arranged on the touch screen. Each touch-controlled light-emitting module includes a light-emitting diode (131) and a silicon controlled rectifier (132) electrically connected to the corresponding light-emitting diode in series. The silicon controlled rectifier is configured for turning on or off the corresponding light-emitting diode based on a control signal. The trigger electrodes spatially correspond to the respective touch-controlled light-emitting modules. Each trigger electrode is electrically connected to one corresponding silicon controlled rectifier and configured for receiving the control signal and transmitting the control signal to the corresponding silicon controlled rectifier.

### BACKGROUND OF THE INVENTION

1. Field of the Invention

The present invention relates to display devices and, particularly, to a touch control display device.

2. Description of Related Art

With the rapid developments of science and technology, portable electronic devices, such as notebook computer, personal digital assistant (PDA), mobile phone, global positioning system (GPS) and multimedia player, are widely used in people's life. A typical portable electronic device is equipped with a number of mechanical keys, and a display for displaying information (e.g., characters, pictures, etc.) thereon. The displayed information is inputted by the mechanical keys. However, with the developing trends of the portable electronic devices becoming more and more multifunctional and miniaturized, the approach of pressing mechanical keys would make the input of information for display more complex and therefore unsatisfactory.

Therefore, what is needed is a touch control display device, which would greatly simplify the input function of the portable electronic device.

### SUMMARY OF THE INVENTION

A touch control display device, according to an embodiment, includes a base plate, a touch screen panel arranged on the base plate, a plurality of touch-controlled light-emitting modules arranged on the base plate, and a plurality of trigger electrodes arranged on the touch screen panel. Each touch-controlled light-emitting module includes a light-emitting diode and a silicon controlled rectifier electrically connected to the corresponding light-emitting diode in series. The silicon controlled rectifier is configured for turning on or off the corresponding light-emitting diode based on a control signal. The trigger electrodes spatially correspond to the respective touch-controlled light-emitting modules. Each trigger electrode is electrically connected to one corresponding silicon controlled rectifier and configured for receiving the control signal and transmitting the control signal to the corresponding silicon controlled rectifier.

The present touch control display device is equipped with the touch screen panel having the plurality of trigger electrodes arranged thereon, and the plurality of touch-controlled light-emitting modules, each having the silicon controlled rectifier and the light-emitting diode, thus display information can be inputted by directly touching the touch screen panel instead of pressing mechanical keys. Accordingly, the present touch control display device can greatly simplify the input function of the portable electronic device.

Other advantages and novel features of the present invention will become more apparent from the following detailed description of at least one preferred embodiment when taken in conjunction with the accompanying drawings.

### BRIEF DESCRIPTION OF THE DRAWINGS

Many aspects of the present touch control display device can be better understood with reference to the following drawings. The components in the drawings are not necessarily to scale, the emphasis instead being placed upon clearly illustrating the principles of the present touch control display device. Moreover, in the drawings, like reference numerals designate corresponding parts throughout the several views.

FIG. 1 is a schematic view of a touch control display device, according to a embodiment of the present invention;

FIG. 2 is a schematic, crossed-section view of the touch control display device of FIG. 1; and

FIG. 3 is a circuit diagram of the touch control display device of FIG. 1.

### DETAILED DESCRIPTION OF THE INVENTION

Reference will now be made to the drawings to describe, in detail, at least one preferred embodiment of the present infrared remote control module.

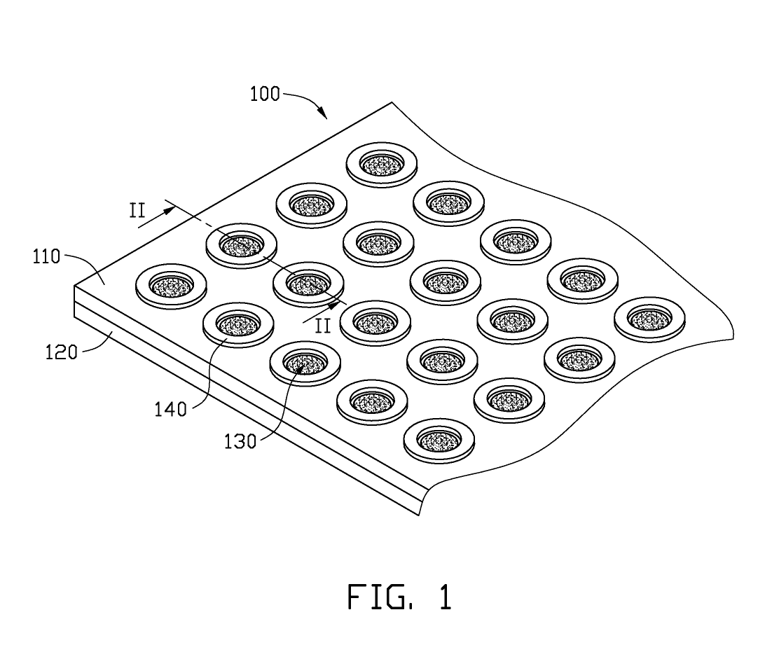

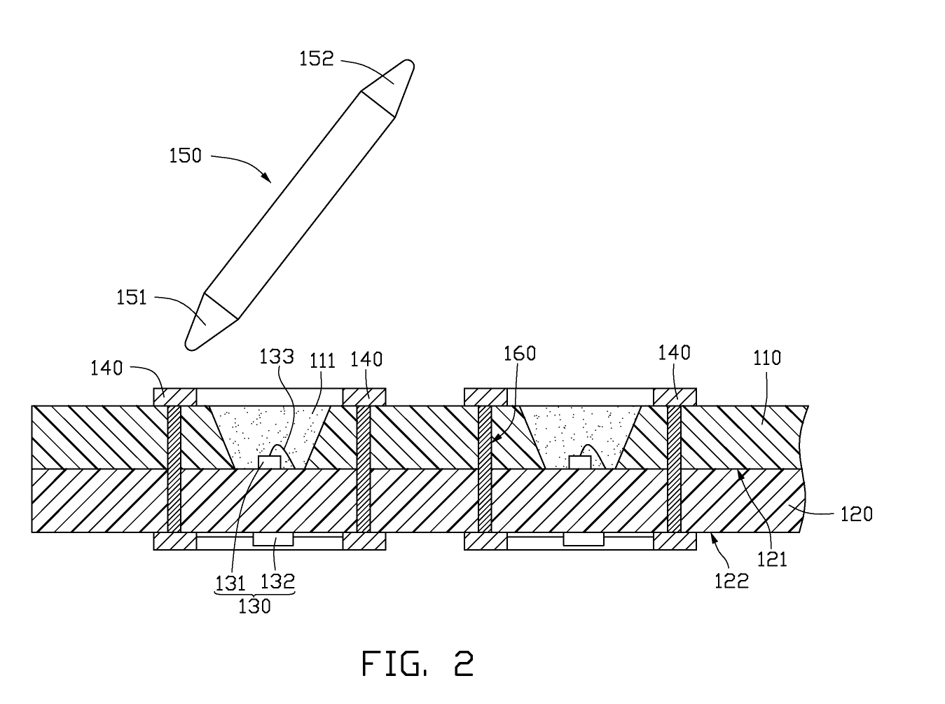

Referring to FIGS. 1 and 2, a touch control display device 100, in accordance with a present embodiment, is provided. The touch controlled display device 100 includes: a base plate 120, a touch screen panel 110 arranged on the base plate 120, a plurality of touch-controlled light-emitting modules 130 arranged on the base plate 120, and a plurality of trigger electrodes 140 arranged on the touch screen panel 110.

The touch screen panel 110 includes a plurality of through holes 111 defined therein. The plurality of touch-controlled light-emitting modules 130 are aligned to form an array. Each of the touch-controlled light-emitting modules 130 corresponds to a pixel of the present touch control display device 100. Each touch-controlled light-emitting module 130 includes a light-emitting diode 131 received in the respective through hole 111, and a silicon controlled rectifier 132 electrically connected to the corresponding light-emitting diode 131. The silicon controlled rectifier 132 is configured for turning on/off the corresponding light-emitting diode 131 based on a control signal.

The plurality of trigger electrodes 140 are arranged on the touch screen panel 110 to form an array. The trigger electrodes 140 spatially correspond to the respective touch-controlled light-emitting modules 130. Each trigger electrode 140 is electrically connected to one corresponding silicon controlled rectifier 132 and configured for receiving the control signal and transmitting the control signal to the corresponding silicon controlled rectifier 132. Each trigger electrode 140 may be ring-shaped and transparent.

The base plate 120 has a first surface 121 and an opposite second surface 122. The light-emitting diodes 131 of the touch-controlled light-emitting modules 130 are arranged on the first surface 121 of the base plate 120 and received in the respective through holes 111 of the touch screen panel 110. The silicon controlled rectifiers 132 of the touch-controlled light-emitting modules 130 are arranged on the opposite second surface 122 of the base plate 120. A transparent plastic material is filled in each of the through holes 111 of the touch screen panel 110. A plurality of electrically conductive members 160 extend through the touch screen panel 110 and the base plate 120, and electrically connect the trigger electrodes 140 with the respective silicon controlled rectifiers 132 The electrically conductive members 160 may be made of copper.

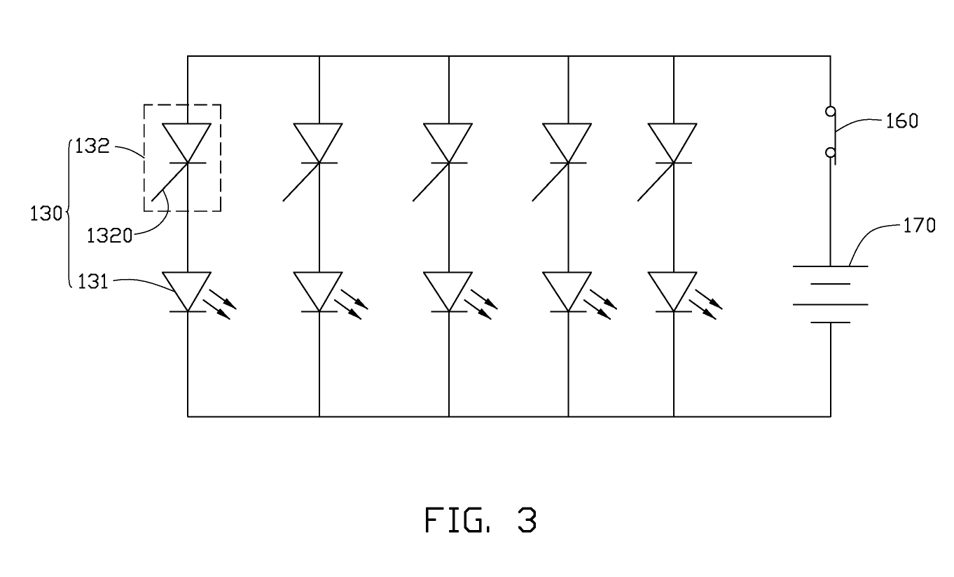

Each silicon controlled rectifier 132 has a gate terminal 1320 (as shown in FIG. 3) configured for receiving the control signal to control the on/off state of the silicon controlled rectifier 132, which also controls the on/off state of the corresponding light-emitting diode 131. When the gate terminal 1320 of the silicon controlled rectifier 132 receives a high-voltage control signal, the silicon controlled rectifier 132 is turned on, and the corresponding light-emitting diode 131 electrically connecting to the silicon controlled rectifier 132 is also turned on. When the gate terminal 1320 of the silicon controlled rectifier 132 receives a zero-voltage control signal, the silicon controlled rectifier 132 is in the off state, and the corresponding light-emitting element 131 electrically connecting thereto is also in the off state.

The present touch control display device 100 further includes a trigger device 150 having a first terminal 151 and a second terminal 152. The first terminal 151 thereof can output the high-voltage control signal, and the second terminal 152 thereof can output the zero-voltage control signal. Thus, if the first terminal 151 of the trigger device 150 electrically contacts one trigger electrode 140, the corresponding silicon controlled rectifier 132 electrically connecting the trigger electrode 140 is turned on; and if the second terminal 152 of the trigger device 150 electrically contacts one trigger electrode 140, the corresponding silicon controlled rectifier 132 is turned off. In this exemplary embodiment, the trigger device 150 is a touch control pen, and has an elongated body. Users may employ the trigger device 150 to respectively turn on or off the corresponding light-emitting elements 131. As a result, expected information will be displayed on the touch control display device 100 by turn on or off the corresponding light-emitting elements 131.

Referring to FIG. 3, a circuit diagram of the present touch control display device 100, is shown. The touch control display device 100 may further include a power supply 170 and a switch 160. The touch-controlled light-emitting modules 130 are connected to each other in parallel. Each touch-controlled light-emitting module 130 forms a closed loop with the power supply 170 and the switch 160. In this exemplary embodiment, the switch 160 is a normally-closed switch, thus each touch-controlled light-emitting module 130 is controlled by employing the trigger device 150 to contact the gate terminals 1320 of the silicon controlled rectifiers 132. If the switch 160 is open, all the light-emitting diodes 131 are turned off, and the expected information displayed on the touch control display device 100, will disappear.

Due to the fact that the present touch control display device 100 is equipped with the touch screen panel 110 having the trigger electrodes 140 arranged thereon, and the plurality of touch-controlled light-emitting modules 130, each having the silicon controlled rectifier 132 and the light-emitting diode 131, thus display information can be inputted by directly touching the touch screen panel 110 instead of pressing mechanical keys. Accordingly, the present touch control display device 100 can greatly simplify the input function of the portable electronic device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A touch control display device, comprising:
a base plate;
a touch screen panel arranged on the base plate, the touch screen panel including a plurality of through holes;
a plurality of touch-controlled light-emitting modules arranged on the base plate, each touch-controlled light-emitting module comprising a light-emitting diode received in the respective through hole and a silicon controlled rectifier electrically connected to the corresponding light-emitting diode in series, the silicon controlled rectifier being configured for turning on or off the corresponding light-emitting diode based on a control signal;
a plurality of trigger electrodes arranged on the touch screen panel, the trigger electrodes spatially corresponding to the respective touch-controlled light-emitting modules, each trigger electrode being electrically connected to one corresponding silicon controlled rectifier, and each trigger electrode being configured for receiving the control signal and transmitting the control signal to the corresponding silicon controlled rectifier.

2. The touch control display device as claimed in claim 1, wherein the silicon controlled rectifier has a gate terminal configured for receiving the control signal to control the on/off state of the silicon controlled rectifier, which in turn controls the on/off state of the corresponding light-emitting diode.

3. The touch control display device as claimed in claim 2, wherein the plurality of trigger electrodes are respectively electrically connected to the gate terminals of the silicon controlled rectifiers.

4. The touch control display device as claimed in claim 1, wherein each trigger electrode is ring-shaped.

5. The touch control display device as claimed in claim 1, wherein each trigger electrode is transparent.

6. The touch control display device as claimed in claim 3, further comprising a trigger device having a first terminal and a second terminal, the first terminal being configured for outputting a high-voltage control signal, the second terminal being configured for outputting a zero-voltage control signal, when the first terminal of the trigger device electrically contacts one trigger electrode, the corresponding silicon controlled rectifier is switched to be in the on state; and when the second terminal of the trigger device electrically contacts one trigger electrode, the corresponding silicon controlled rectifier is switched to be in the off state.

7. The touch control display device as claimed in claim 6, wherein the trigger device has an elongated body.

8. The touch control display device as claimed in claim 1, wherein a transparent plastic material is filled in each of through holes of the touch screen panel.

9. The touch control display device as claimed in claim 1, wherein the base plate has a first surface and an opposite second surface, the light-emitting diode is arranged on the first surface thereof, and the silicon controlled rectifier is arranged on the second surface thereof.

10. The touch control display device as claimed in claim 2, further comprising a plurality of electrically conductive member extending through the base plate and the touch screen panel, and electrically connecting the trigger electrodes to the respective gate terminals of the silicon controlled rectifiers.

11. The touch control display device as claimed in claim 1, further comprising a switch and a power supply, wherein the touch-controlled light-emitting modules are connected to each other in parallel, each touch-controlled light-emitting module, the switch and the power supply forming a closed loop.

12. The touch control display device as claimed in claim 11, wherein the switch is a normally-closed switch.
